(19) United States
(12) Patent Application Publication
(10) Pub. No.: US 2013/0173946 A1
(43) Pub. Date: Jul. 4, 2013

(54) CONTROLLING POWER CONSUMPTION THROUGH MULTIPLE POWER LIMITS OVER MULTIPLE TIME INTERVALS

(71) Applicants: Efraim Rotem, Haifa (IL); Avinash N. Ananthakrishnan, Hillsboro, OR (US); Doron Rajwan, Rishon Le-Zion (IL); Eliezer Weissmann, Haifa (IL); Alon Naveh, Ramat Hasharon (IL); James G. Hermerding, II, Vancouver, WA (US); Riad Durr, Haifa (IL); Hisham Abu Salah, Majdal shams (IL)

(72) Inventors: Efraim Rotem, Haifa (IL); Avinash N. Ananthakrishnan, Hillsboro, OR (US); Doron Rajwan, Rishon Le-Zion (IL); Eliezer Weissmann, Haifa (IL); Alon Naveh, Ramat Hasharon (IL); James G. Hermerding, II, Vancouver, WA (US); Riad Durr, Haifa (IL); Hisham Abu Salah, Majdal shams (IL)

(21) Appl. No.: 13/340,433

(22) Filed: Dec. 29, 2011

(51) Int. Cl. G06F 1/26

(52) U.S. Cl. 713/340; 713/300

(57) ABSTRACT

Methods and apparatus relating to controlling power consumption through multiple power limits over multiple time intervals are described. In one embodiment, the level of power consumption by a computing device component (e.g., a processor or one of its processor cores) is modified based on a determined power limit value. The power limit value may be determined based on rolling power consumption averages over multiple time intervals and their comparison against multiple corresponding power limits. Other embodiments are also disclosed and claimed.

### FIELD

The present disclosure generally relates to the field of electronics. More particularly, an embodiment of the invention relates to controlling power consumption through multiple power limits over multiple time intervals.

### BACKGROUND

As integrated circuit (IC) fabrication technology improves, manufacturers are able to integrate additional functionality onto a single silicon substrate. As the number of these functionalities increases, however, so does the number of components on a single IC chip. Additional components add additional signal switching, in turn, generating more heat. The additional heat may damage an IC chip by, for example, thermal expansion. Also, the additional heat may limit usage locations and/or applications of a computing device that includes such chips. For example, a portable computing device may solely rely on battery power for its operations. Hence, as additional functionality is integrated into portable computing devices, the need to reduce power consumption becomes increasingly important, for example, to maintain battery power for an extended period of time. Non-portable computing systems also face cooling and power generation issues as their IC components use more power and generate more heat.

To improve performance, some processors may use a “turbo” mode. For example, turbo mode may allow a processor to increase the supply voltage and/or frequency up to a pre-defined Thermal Design Power (TDP) limit, for example due to workload demands. However, the TDP limit may be set based on steady state conditions, which result in latency even when the TDP limit may be exceeded without causing thermal issues. Other turbo techniques may make use of dynamic characteristics of cooling system. These dynamic characteristics of TDP limit may however, be significantly variable from one system to the next system and unacceptable to equipment manufacturers or end users.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 6, and 7 illustrate block diagrams of embodiments of computing systems, which may be utilized to implement various embodiments discussed herein.

FIGS. 2-3 illustrate block diagrams according to some embodiments of invention.

FIGS. 4A and 4B illustrate flow diagrams according to some embodiments.

FIG. 5 illustrates a timing diagram according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may provide efficient and flexible power management for computing systems and/or processors (including general purpose processors, graphics processors, etc.). In an embodiment, power consumption is controlled over multiple time intervals, e.g., with multiple power limits. More particularly, computer systems generally have multiple power constraints and a processor may be shipped with a rated power consumption, e.g., measured over some “thermally significant time”. OEMs (Original Equipment Manufacturers) who build computing systems need to design for multiple constraints of the whole platform. These power constraints, in turn, impact the system over different time intervals.

Examples of some (but not all) system power constraints include: (a) processor chip voltage regulator maximum instantaneous current (which may include limits associated with the power delivery network—passive components that construct the VR (Voltage Regulator) filtering network and may have a time interval of microseconds for example); (b) processor chip voltage regulator maximum sustained current (which may include limits associated with usually heating of the VR components or board connection and which may have a time interval of seconds for example); (c) a battery feeding total system power consumption (which may include limits associated with chemistry and/or capacity of the battery and which may have a time interval of micro to milliseconds); (d) internal/external Power Supply Unit (PSU) instantaneous power, feeding total system power consumption (which may include limits associated with passive components that construct the PSU filtering network and which may have a time interval of milliseconds for example); (e) internal/external PSU sustained power, feeding total system power consumption (which may include limits associated with heating on the PCU (Power Control Unit) components and which may have a time interval of seconds for example); and/or (f) various thermal limitations of individual system/platform components, ergonomic limitation of skin temperature, fan acoustic noise etc. (which may include limits associated with cooling and which have a time interval of seconds to minutes for example).

Moreover, since in most implementations the processor package (processor, GT (Graphics), memory controller, etc.) and/or its surrounding components (DDR (Double Data Rate) memory, PCH (Peripheral Control Hub), etc.) are the dominant power consumers in the system, managing the above-mentioned components may be done by utilizing a static setting or an active control scheme, e.g., aimed at limiting the processor package power over a time interval, e.g., as described above.

In some embodiments, a power management mechanism is used to control power consumption over multiple (i.e., two or more) time intervals. The power limits and time may be set either statically (e.g., one time at system boot) or dynamically on the fly (e.g., as a response to changing system or device conditions). In various embodiments, the power limits may be set by BIOS (Basic Input/Output System), operating system via MSR (Machine State Register or Model Specific Register, which may be used to control and/or receive information regarding processor performance and may only handle system functions and may not be accessible by application programs), MMIO (Memory Mapped Input/Output), external embedded controller, central power manager of a system, computer rack, or a data center, etc. In other embodiments, the power limits and time may be reported by a “smart power supply” or “smart battery” (e.g., where the power supply communicates its maximum capability to the system via some data link).

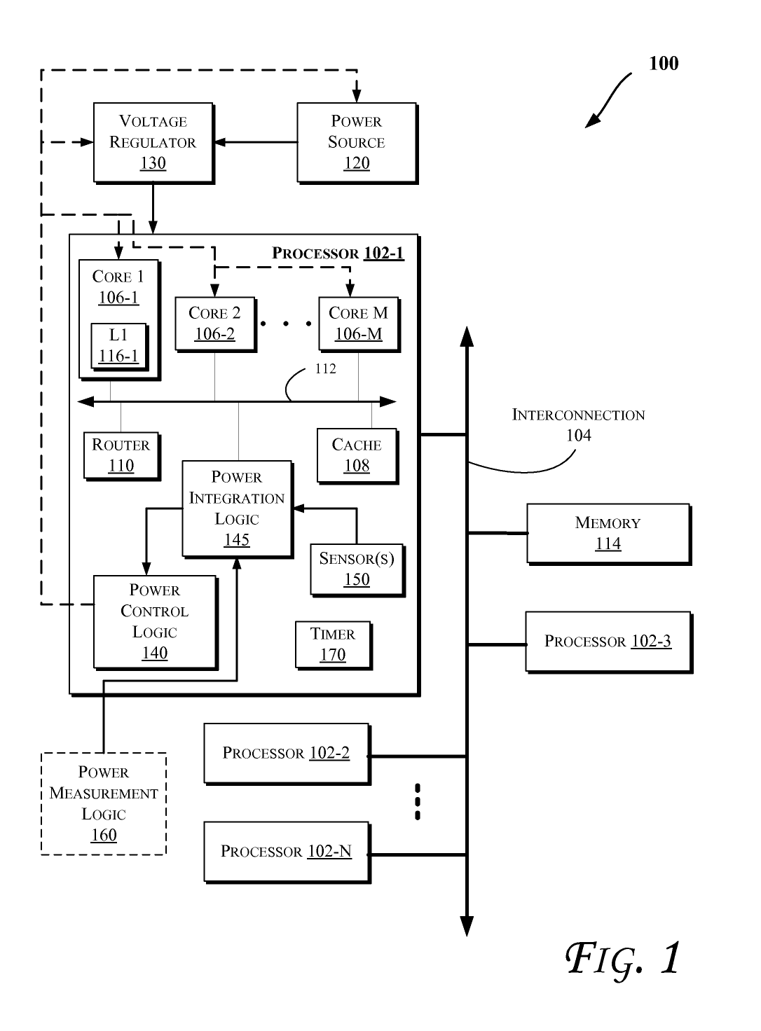

Moreover, some embodiments may be applied in computing systems that include one or more processors (e.g., with one or more processor cores), such as those discussed with reference to FIGS. 1-7. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

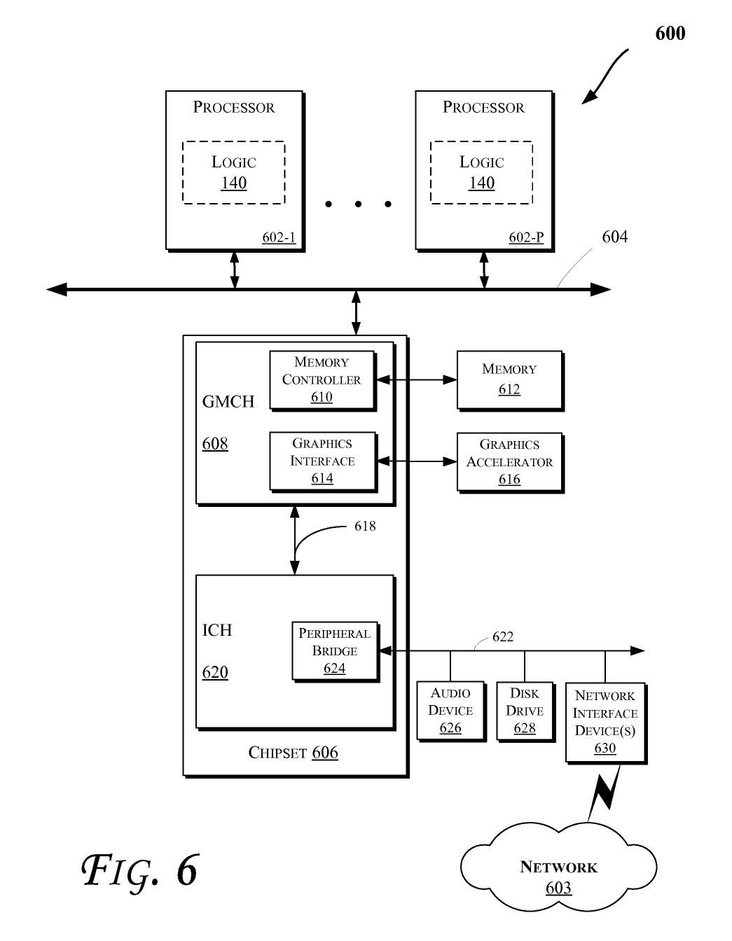

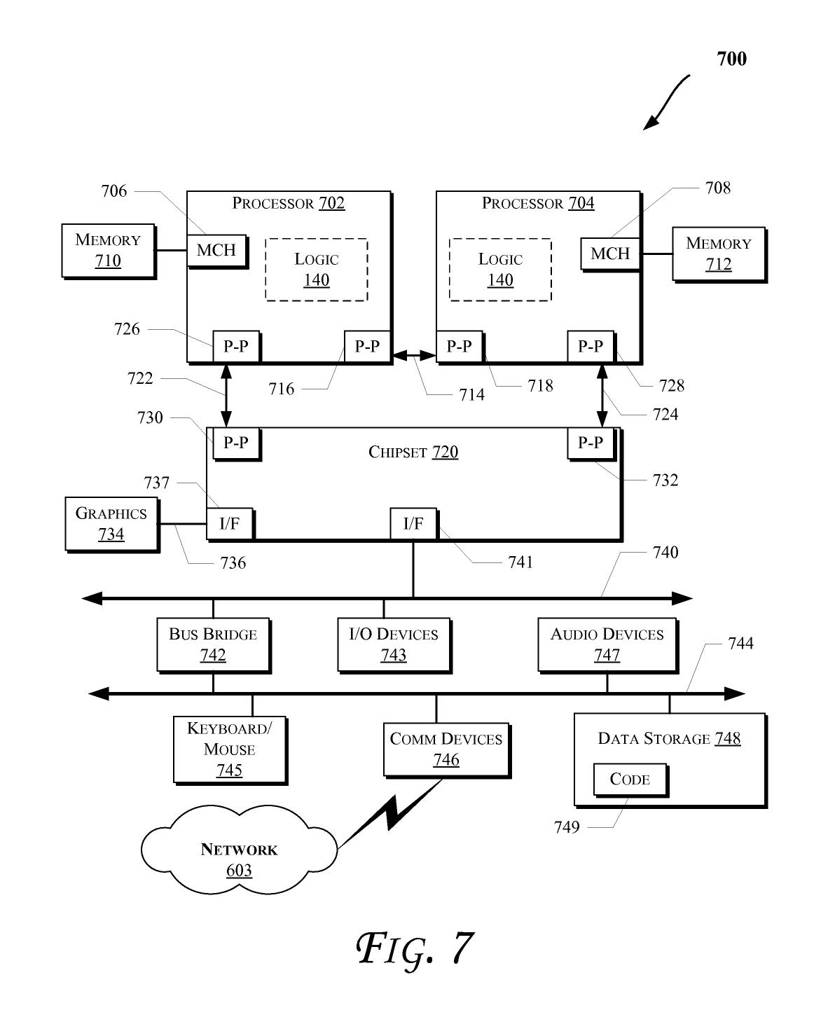

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 6-7), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a power source 120 (e.g., a direct current (DC) power source or an alternating current (AC) power source) to provide power to one or more components of the system 100. In some embodiments, the power source 120 may include one or more battery packs and/or power supplies. The power source 120 may be coupled to components of system 100 through a voltage regulator (VR) 130. Moreover, even though FIG. 1 illustrates one power source 120 and one voltage regulator 130, additional power sources and/or voltage regulators may be utilized. For example, each of the processors 102 may have corresponding voltage regulator(s) and/or power source(s). Also, the voltage regulator(s) 130 may be coupled to the processor 102 via a single power plane (e.g., supplying power to all the cores 106) or multiple power planes (e.g., where each power plane may supply power to a different core or group of cores).

Additionally, while FIG. 1 illustrates the power source 120 and the voltage regulator 130 as separate components, the power source 120 and the voltage regulator 130 may be incorporated into other components of system 100. For example, all or portions of the VR 130 may be incorporated into the power source 120 and/or processor 102.

As shown in FIG. 1, the processor 102 may further include a power control logic 140 to control supply of power to components of the processor 102 (e.g., cores 106). Logic 140 may have access to one or more storage devices discussed herein (such as cache 108, L1 cache 116, memory 114, or another memory in system 100) to store information relating to operations of logic 140 such as information communicated with various components of system 100 as discussed here. As shown, the logic 140 may be coupled to the VR 130 and/or other components of system 100 such as the cores 106 and/or the power source 120. For example, the logic 140 may be coupled to receive information (e.g., in the form of one or more bits or signals) to indicate status of one or more sensors 150 (where the sensor(s) 150 may be provided proximate to components of system 100 (or other computing systems discussed herein such as those discussed with reference to other figures including 6 and 7, for example), such as the cores 106, interconnections 104 or 112, etc., to sense variations in various factors affecting power/thermal behavior of the system, such as temperature, operating frequency, operating voltage, power consumption, inter-core communication activity, etc.) and/or information from a power integration logic 145 (e.g., which may indicate the operational status of various components of system 100 such as architectural events and power estimation(s) corresponding to cores 106, which may be provided to logic 145 by the cores 106 directly, or via interconnection 112). In an embodiment, variations may be sensed in such a way to account for leakage versus active power. The logic 140 may in turn instruct the VR 130, power source 120, and/or individual components of system 100 (such as the cores 106) to modify their operations. For example, logic 140 may indicate to the VR 130 and/or power source 120 to adjust their output. In some embodiments, logic 140 may request the cores 106 to modify their operating frequency, power consumption, etc. Also, even though components 140, 145, and 150 are shown to be included in processor 102-1, these components may be provided elsewhere in the system 100. For example, power control logic 140 may be provided in the VR 130, in the power source 120, directly coupled to the interconnection 104, within one or more (or alternatively all) of the processors 102, etc. Furthermore, as shown in FIG. 1, the power source 120 and/or the voltage regulator 130 may communicate with the power control logic 140 and report their power specification.

As shown in FIG. 1, the system 100 may include a power measurement logic 160, which may be provided inside the processor or external to the processor 102 (such as shown). In an embodiment, the logic 160 may measure actual power consumption levels (e.g., based on current voltage and/or electrical current measurements) by one or more of cores 106 (or more generally the processor 102). In some embodiments, the measurement by the power measurement logic 160 may be performed by executing software or firmware. In another embodiment, the power measurement logic 160 may track architectural activity or state of the processor (e.g., to predict values in addition to or instead of actual measurements). In an embodiment, logic 160 may be coupled to the VR 130 and/or power source 120 to measure actual current or power consumption by the processor 102. In another embodiment, the power measurement logic 160 may be integrated into the VR 130 and/or power source 120.

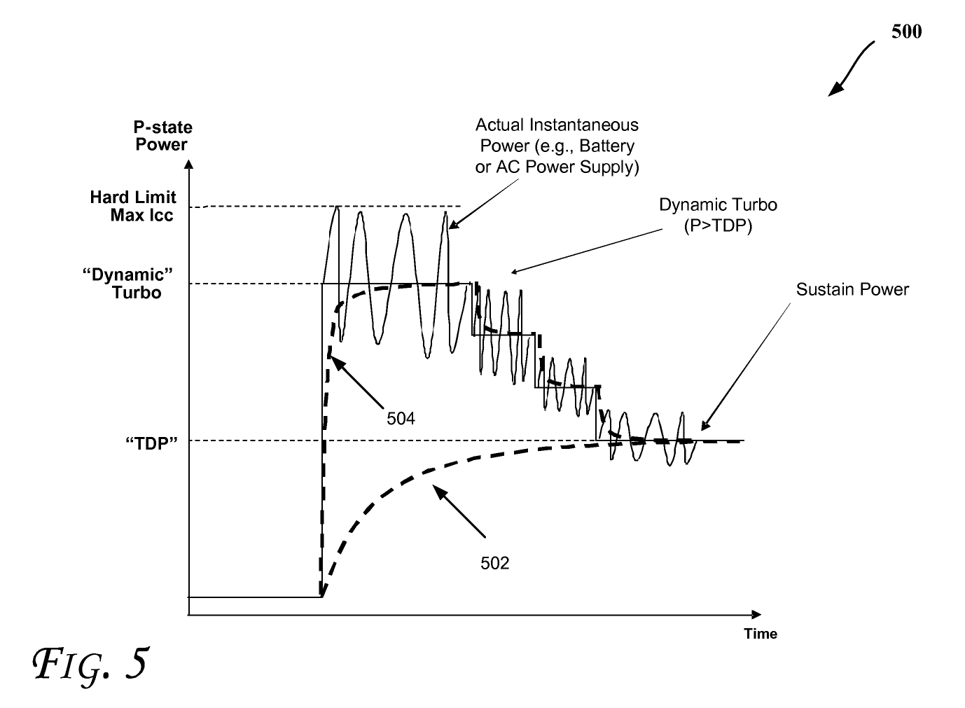

In an embodiment, the logic 140 and/or logic within the cores 106 may determine one or more power level budgets or limits (e.g., for one or more of the cores 106, or the processor 102 more generally) over one or more time intervals, e.g., based on TDP values, rolling averages, and/or actual power levels during thermally significant time intervals. As discussed herein, “thermally significant time intervals” generally refers to the heat sink thermal response time interval, which may be in the order of many seconds in some embodiments. For example, logic 140 and/or logic within the cores 106 (not shown) may perform a power calculation function (implemented as a firmware in an embodiment) which tracks power levels during thermally significant intervals (e.g., samples at the rate of 10^{th} of mS in one embodiment), e.g., where the intervals may be determined by the timer 170. For example, timer 170 may generate a signal that indicates when to sample power levels. Furthermore, the power budgets may be set by electrical limitations (rather than thermal). For example, power consumption may be limited over a period of microseconds to few milliseconds to meet the power supply limitations. In some embodiments, a first power limit (referred to herein as PL1, e.g., with reference to FIG. 5) is for thermally significant time over many seconds and a second power limit (referred to herein as PL2, e.g., with reference to FIG. 5) in 100s of microseconds to a few milliseconds is for electrical limitations.

In an embodiment, the power control logic 140 and/or logic within the cores 106 may define a power budget as Budget (with a constraint of Budget>=0):

$$Budget = {\int }_{0}^{t} {α}^{t - x} ( TDP ( x ) - P ( x ) ) d x \geq 0 \qquad ( 1 )$$

where Budget refers to power level which may be reached during a turbo opportunity period for one or more of the processor cores 106 (or the processor 102 more generally) that exceed the pre-defined TDP, α refers to a constant indicative of time respond behavior, x refers sampling points during thermally significant time interval t (e.g., 10^{th} of mS in one embodiment), t refers to a thermally significant time measured in seconds, P(x) refers to actual power consumption level at sampling point x (e.g., as determined by logic 160), and TDP(x) refers to the TDP defined for sampling point x (e.g., which may be stored in a storage device of processor 102).

More particularly, the outcome of the above calculation may correspond to a prediction of the processor junction temperature (Tj) under thermal model represented by this equation including heat sink mass and thermal conductivity and the standard ambient temperature defined in the part specifications in some embodiments. Since the calculation may be performed under standard ambient conditions, e.g., according to the worse case part specifications, it predicts the worst case temperature across the entire population. The power control logic 140 may invoke power management actions such as dynamic voltage and/or frequency scaling (e.g., by instructing VR 130, power source 120, and/or cores 106) based on the calculation to fit the processor 102 into the requisite thermal specifications.

In another embodiment of the invention, the power limit may be controlled by the use of a formal control loop such as PID (Proportional Integral Derivative—see, e.g., http://en.wikipedia.org/wiki/PID_controller). In yet another embodiment of the invention, the power limit may be controlled by the use of power thresholds and activate power reduction as an immediate response to threshold crossing.

In an embodiment, available power headroom may be used to extract the performance potential in a deterministic way such that it reduces or even eliminates the product-to-product variations. For example, in an embodiment, a thin and light notebook may run four bins higher for a period of about 90 seconds by applying the techniques discussed herein. Accordingly, some embodiments may significantly improve user perceived performance while mitigating equipment manufacturer concerns about consistent behavior of a product. Also, human use of computers may be characterized by short bursts of compute cycles with pause intervals in between for data entry, reading, thinking, etc. During the compute burst periods, a significantly higher performance than non-dynamic behavior may be achieved in an embodiment. This in turn reduces or eliminates one of the key gating items to dynamic performance which may be non-deterministic behavior. Also, it is understood that other calculations may be performed to achieve similar functionality. Alternatively the above equation may be replaced with a EWMA (Exponentially Weighted Moving Average) Low Pass Filter. It is also possible to use time intervals in power states. Also, upper and lower limits to the power targets may be applied. Furthermore, the dynamic/responsiveness generally comes at cost of high power that may break the power delivery of the OEM and needs to be controlled.

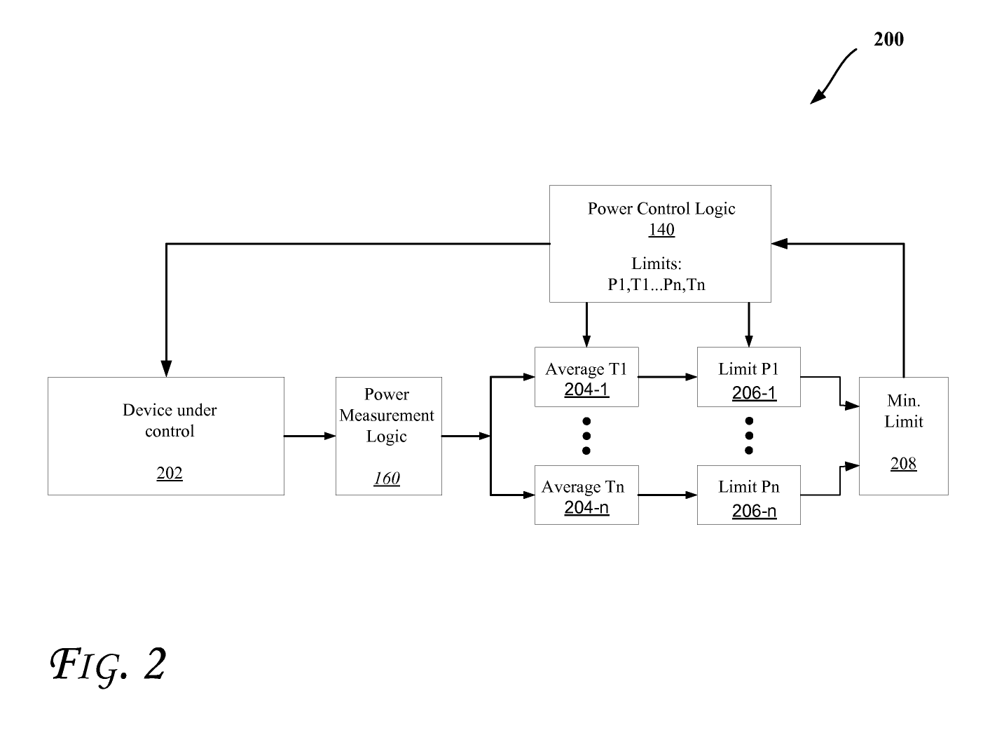

FIG. 2 illustrates a block diagram of a power management system 200, according to an embodiment. In an embodiment, one or more control registers store a set of limit pairs of power (P) and time (T). The power control logic 140 (which may also be referred to interchangeable as a Power Management Unit (PMU)) may access the one or more registers to read/write the set of limit pairs. The power measurement logic 160 may collect information regarding power consumption of the device being controlled 202 (such as the CPU package, processor 102, processor cores 106, etc.). For each power limit, a rolling average over a given time interval (e.g., 204-1 to 204-n) is calculated and compared against the corresponding power limit(s) (e.g., 206-1 to 206-n). The most constraining limit 208 may then be selected and used (by the logic 140) to control the power consumption of the device 202. Accordingly, FIG. 2 describes an implementation where the control is being performed by the power control logic 140. In some embodiments, the rolling average, the limit control, and comparing may be done in a dedicated hardware device, the logic 140 as hardware, firmware, or software (such as a device driver). It is understood that the time may be 0, i.e. instantaneous response at the fastest possible speed that the power control unit 140 may react to.

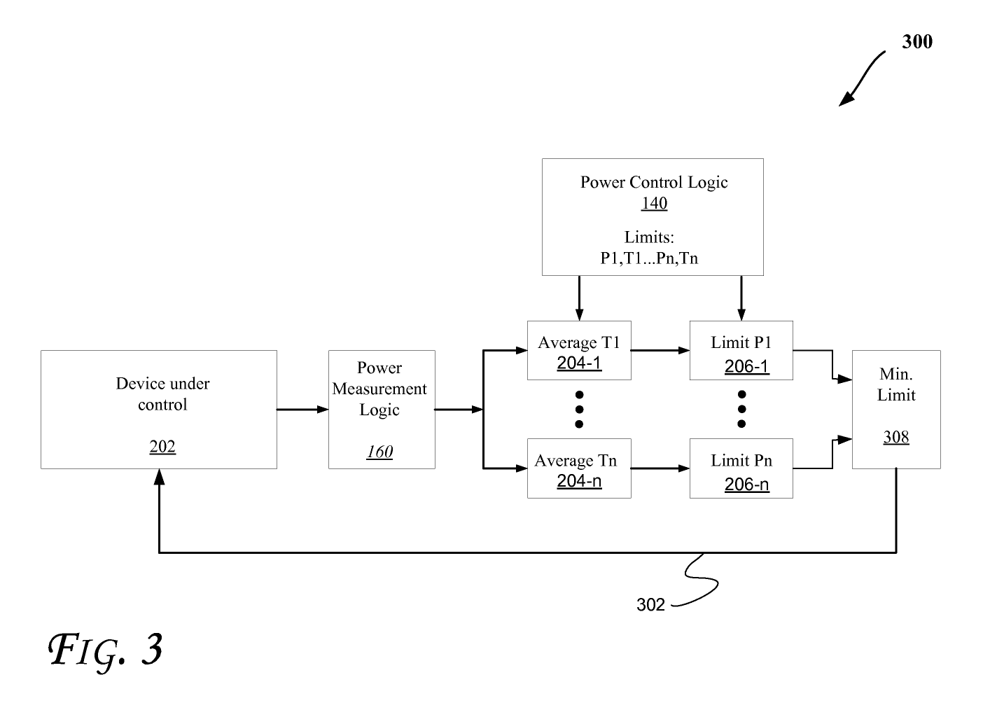

FIG. 3 illustrates a block diagram of a power management system 300, according to an embodiment. When compared with FIG. 2, FIG. 3 shows a different implementation where the power control is done using a direct hardware feedback 302 instead of going through the logic 140 to control the power consumption of the device 202. Rather, limiting the power consumption may be done by lowering voltage and frequency, lowering frequency only, changing voltage only, throttling techniques, closing or powering off one or more functional blocks, etc. in the device under control 202 based on the determined minimum limit 308. Power reduction generally comes at a cost of lowering the performance. In systems such as real time systems or applications such as video and/or audio, lowering the performance too much may cause a loss in quality of service requirements or audible/visual artifacts. On the other hand, too high power limit may cause permanent damage to the part or the system components. Therefore, upper and lower limits to the power targets may be applied.

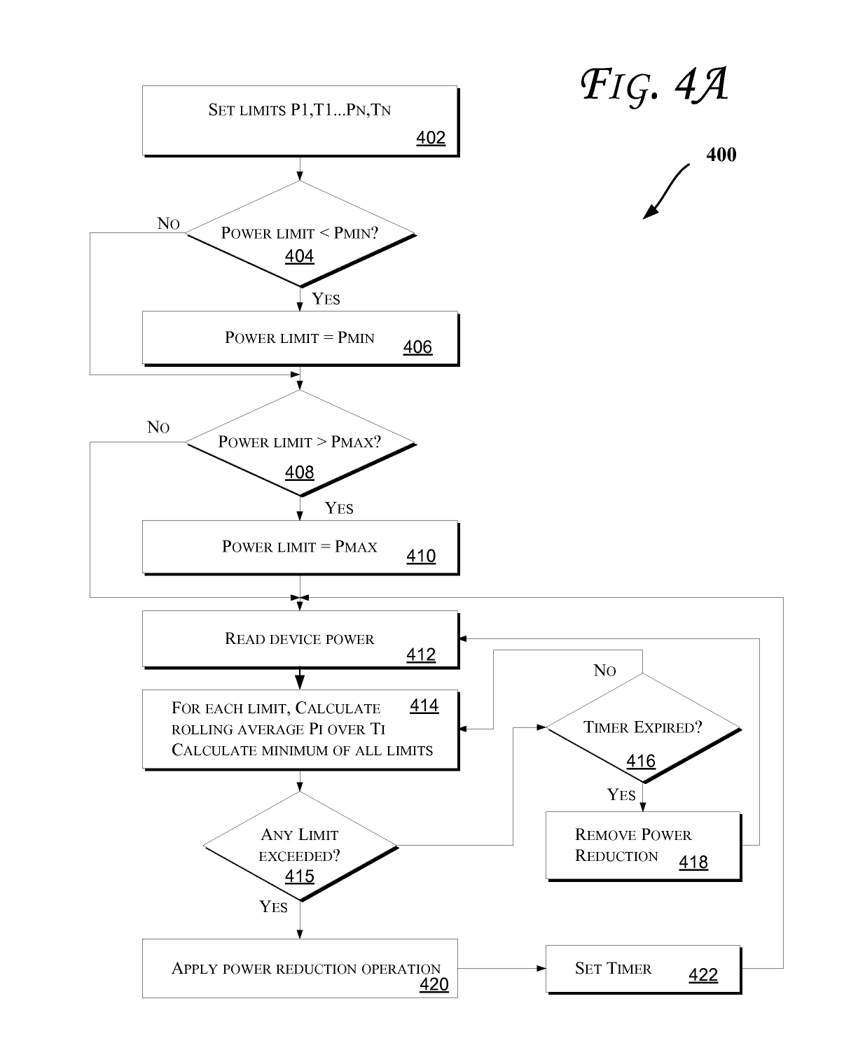

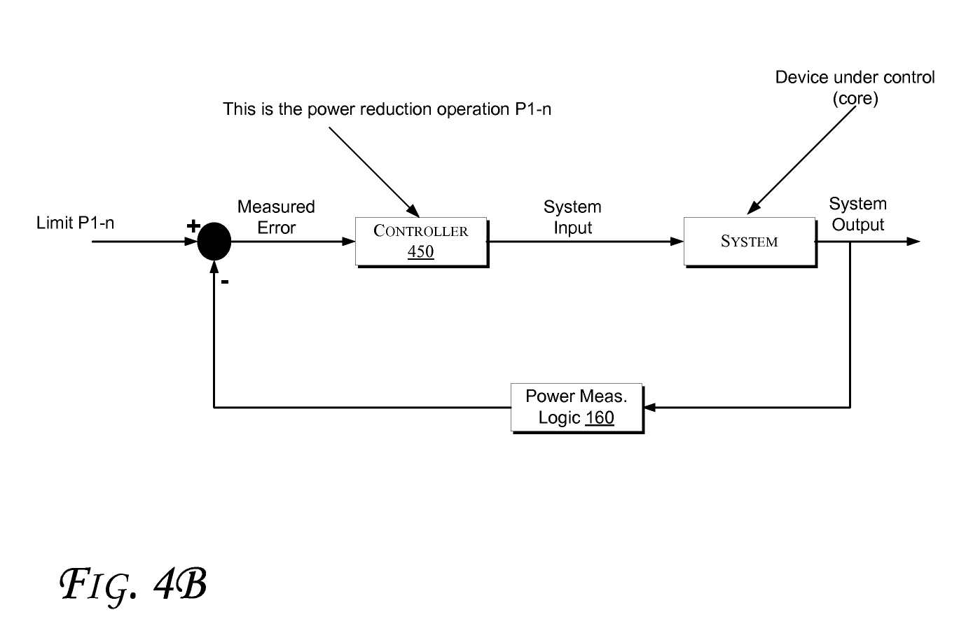

FIG. 4A illustrates a flow diagram of an embodiment of a method 400 to control power consumption through multiple power limits over multiple time intervals, according to some embodiments. In an embodiment, various components discussed with reference to FIGS. 1-3 and 6-7 may be utilized to perform one or more of the operations discussed with reference to FIG. 4A. It is understood that operation 402 may be performed dynamically at any time and not only once at system initiation.

Referring to FIGS. 1-4A, at an operation 402, set of limit pairs of power (P) and time (T) may be set (e.g., stored in one or more registers, table entries, and/or in storage device such as those discussed with reference to FIGS. 1-3 and 6-7. At an operation 404, it may be determined whether the power limit is less than a minimum power limit. If it is, then the current power limit is set to the a minimum power limit at an operation 406. If the power limit is not less than a minimum power setting, it may be determined whether a maximum power limit has been exceeded at an operation 408. If it has, then the current power limit is set to the maximum power limit at an operation 410. If the maximum power limit has not been exceeded, the device power is read at an operation 412 (e.g., by/from the power measurement logic 160).

At an operation 414, for each limit, rolling average(s) for P over T may be determined to detect the minimum of all limits (e.g., minimums 208 or 308). In an embodiment, an average value of power consumption may correspond to a sum of power consumption of at least one of a plurality of system components (e.g., the sum of CPU, graphics DDR memory, chip-set or any sub set of them). At an operation 415, it may be determined whether any limits have been exceeded. If not, method 400 checks a timer at operation 416. If the timer has expired, method 400 continues at operation 418 to remove throttling; otherwise, operation 414 is resumed. Instead of a timer check (e.g., operation 416) hysteresis may be used (if the power limit is reached by some value rather than time) in an embodiment. After operation 418, method 400 resumes at operation 412. If limit has been exceeded per operation 415, operation 420 applies power reduction techniques. For example, limiting the power consumption may be done by lowering voltage and frequency, lowering frequency only, changing voltage only, throttling techniques, closing or powering off one or more functional blocks, etc. After operation 420, the method 400 may continue with operation 422 to set the timer. Method 400 resumes with operation 412 after operation 422. In an embodiment, method 400 may continue with operation 402 after operation 420 (e.g., indicating power reduction may be done at run time). Alternatively, a formal control algorithm such as PID may be applied to the limits and action may be performed based on the differential values of the power from the limits.

In an embodiment, instead of the threshold based control up or down, a formal control may be applied to the differential values as shown in FIG. 4B. As shown, reference limits (P1-n) may be fed into the system and combined with measured output from power measurement logic 160. The combination is fed as measured error to a controller logic 450 (e.g., to perform power reduction operations for P1-n). Output of the controller 450 is fed to the system (device under control such as a processor core) and the system in turn generates a system output.

FIG. 5 illustrates a timing diagram 500 of P-state power over time, according to an embodiment. Diagram 500 illustrates how two power limits (PL1 and PL2) used during multiple intervals, according to one embodiment. However, embodiments of the invention are not limited to two power limits and more power limits may be utilized. As shown, PL1 is the average power control described with reference to the power budget above. This time interval may be in the range of seconds to tens of seconds which controls to the dotted line value (502). PL2 may be a time interval in microseconds to milliseconds that protects power supplies from high current and controls to the line 502, keeping it down to line 504.

In some embodiments, various registers or storage locations may be used to store: turbo power limit data (e.g., time window 1 to N for power limits PL1 to N, enable/disable power limit(s), package power limit(s), various control and mode setting bits, user preferences, etc.); multiple such data structure may exist for multiple power domains (for example, IA core, graphics controller, total package, system memory, etc.) Each of these registers or storage locations may be configurable by a user, OEM, OS, etc.

In various embodiments, the power limits and time may be set either statically (e.g., one time at system boot) or dynamically on the fly or during run time (e.g., as a response to changing system or device conditions). In some embodiments, the power limits may be set by BIOS (Basic Input/Output System), operating system (e.g., via MSR (Machine State Register or Model Specific Register, which may be used to control and/or receive information regarding processor performance and may only handle system functions and may not be accessible by application programs)), MMIO (Memory Mapped Input/Output), external embedded controller, central power manager of a system, computer rack, or a data center, etc. Also, a combination of the above-mentioned system controls may be used to set the power limits and time windows. For example, a minimum of a plurality of the system controls may used to set the power limits and time windows (e.g., even if the time and power come from different sources). In an embodiment, the plurality of power consumption limits and corresponding time intervals are set by at least one of a plurality of system controls (e.g., including one or more of: an operating system, based on memory mapped input/output, a power manager unit of a system, computer rack, or a data center, etc.). It is understood that the proposed power control embodiments are exemplary. Other formal control loops such as PID (Proportional Integral Differential) may be applied to keep the device within the defined power limits.

FIG. 6 illustrates a block diagram of a computing system 600 in accordance with an embodiment of the invention. The computing system 600 may include one or more central processing unit(s) (CPUs) or processors 602-1 through 602-P (which may be referred to herein as “processors 602” or “processor 602”). The processors 602 may communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. In some embodiments, one or more of the processors 602 may include one or more of the cores 106, logic 140, logic 145, logic 160, timer 170, sensor(s) 150, of FIG. 1. Also, the operations discussed with reference to FIGS. 1-5 may be performed by one or more components of the system 600. For example, a voltage regulator (such as VR 130 of FIG. 1) may regulate voltage supplied to one or more components of FIG. 6 at the direction of logic 140. Additionally, system 600 (and/or 700 of FIG. 7) may include an embedded controller (or be coupled to an external embedded controller) to set the power limits discussed herein, in some embodiments.

A chipset 606 may also communicate with the interconnection network 604. The chipset 606 may include a graphics and memory control hub (GMCH) 608. The GMCH 608 may include a memory controller 610 that communicates with a memory 612. The memory 612 may store data, including sequences of instructions that are executed by the processor 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The GMCH 608 may also include a graphics interface 614 that communicates with a graphics accelerator 616. In one embodiment of the invention, the graphics interface 614 may communicate with the graphics accelerator 616 via an accelerated graphics port (AGP). In an embodiment of the invention, a display (such as a flat panel display, a cathode ray tube (CRT), a projection screen, etc.) may communicate with the graphics interface 614 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 618 may allow the GMCH 608 and an input/output control hub (ICH) 620 to communicate. The ICH 620 may provide an interface to I/O devices that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and one or more network interface device(s) 630 (which is in communication with the computer network 603). Other devices may communicate via the bus 622. Also, various components (such as the network interface device 630) may communicate with the GMCH 608 in some embodiments of the invention. In addition, the processor 602 and the GMCH 608 may be combined to form a single chip. Furthermore, the graphics accelerator 616 may be included within the GMCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 600 may be arranged in a point-to-point (PtP) configuration. For example, processors, memory, and/or input/output devices may be interconnected by a number of point-to-point interfaces.

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-6 may be performed by one or more components of the system 700. For example, a voltage regulator (such as VR 130 of FIG. 1) may regulate voltage supplied to one or more components of FIG. 7.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may store various data such as those discussed with reference to the memory 612 of FIG. 6. Also, the processors 702 and 704 may include one or more of the cores 106, logic 140/145/16, timer 170, and/or sensor(s) 150 of FIG. 1.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a high-performance graphics circuit 734 via a high-performance graphics interface 736, e.g., using a PtP interface circuit 737.

In at least one embodiment, one or more operations discussed with reference to FIGS. 1-6 may be performed by the processors 702 or 704 and/or other components of the system 700 such as those communicating via a bus 740. Other embodiments of the invention, however, may exist in other circuits, logic units, or devices within the system 700 of FIG. 7. Furthermore, some embodiments of the invention may be distributed throughout several circuits, logic units, or devices illustrated in FIG. 7.

Chipset 720 may communicate with the bus 740 using a PtP interface circuit 741. The bus 740 may have one or more devices that communicate with it, such as a bus bridge 742 and I/O devices 743. Via a bus 744, the bus bridge 742 may communicate with other devices such as a keyboard/mouse 745, communication devices 746 (such as modems, network interface devices, or other communication devices that may communicate with the computer network 603), audio I/O device, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a tangible machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
first logic to determine a first value of power consumption over a first time interval of a plurality of time intervals, corresponding to a plurality of power consumption limits, and to determine a second value of power consumption over a second time interval of the plurality of time intervals; and
second logic to compare the first value and the second value with two corresponding power consumption limit values from the plurality of power consumption limits to determine a power limit value,
wherein a level of power consumption by the processor is to be modified based on the determined power limit value.

2. The processor of claim 1, further comprising third logic to cause modification to the level of power consumption by the processor based on the determined power limit value.

3. The processor of claim 1, wherein the plurality of power consumption limits and corresponding time intervals are to be set during system boot.

4. The processor of claim 1, wherein the plurality of power consumption limits and corresponding time intervals are to be set during run time.

5. The processor of claim 1, wherein the plurality of power consumption limits and corresponding time intervals are to be set by an operating system.

6. The processor of claim 1, wherein the plurality of power consumption limits and corresponding time intervals are to be determined based on memory mapped input/output.

7. The processor of claim 1, wherein the plurality of power consumption limits and corresponding time intervals are to be set by a power manager unit of a system, computer rack, or a data center.

8. The processor of claim 1, wherein the plurality of power consumption limits and corresponding time intervals are to be set in response to at least one of a plurality of system controls, wherein the plurality of system controls comprise one or more of: an operating system, memory mapped input/output, or a power manager unit of a system, computer rack, or a data center.

9. The processor of claim 1, wherein a timer is to generate a signal indicative of a sampling rate, wherein the first logic is to determine the first value or the second value at the sampling rate.

10. The processor of claim 1, further comprising one or more sensors to detect variations, corresponding to components of the processor, in one or more of: temperature, operating frequency, operating voltage, and power consumption.

11. The processor of claim 1, further comprising third logic to cause a change to a voltage level supplied to the processor and/or an operating frequency of the processor based on the determined power limit value.

12. The processor of claim 1, wherein one or more of the first logic, the second logic, and a memory, which is to store the plurality of time intervals and the plurality of power consumption limits, are on a single integrated circuit.

13. The processor of claim 1, wherein the first value of power consumption corresponds to a first average value of power consumption and the second value of power consumption corresponds to a second average value of power consumption.

14. The processor of claim 1, wherein an average value of power consumption is to correspond to a sum of power consumption of at least one of a plurality of system components.

15. The processor of claim 1, wherein the power limit value is to correspond to a minimum power limit value.

16. A method comprising:
determining a first value of power consumption over a first time interval of a plurality of time intervals, corresponding to a plurality of power consumption limits;
determining a second value of power consumption over a second time interval of the plurality of time intervals; and
comparing the first value and the second value with two corresponding power consumption limit values from the plurality of power consumption limits to determine a power limit value,
wherein a level of power consumption by a processor is to be modified based on the determined power limit value.

17. The method of claim 16, further comprising setting the plurality of power consumption limits and corresponding time intervals during system boot or during run time.

18. The method of claim 16, further comprising setting the plurality of power consumption limits and corresponding time intervals in response to at least one of a plurality of system controls, wherein the plurality of system controls comprise one or more of: an operating system, memory mapped input/output, or a power manager unit of a system, computer rack, or a data center.

19. The method of claim 16, further comprising setting the plurality of power consumption limits and corresponding time intervals by an operating system.

20. The method of claim 16, further comprising setting the plurality of power consumption limits and corresponding time intervals based on memory mapped input/output.

21. The method of claim 16, further comprising setting the plurality of power consumption limits and corresponding time intervals by a power manager unit of a system, computer rack, or a data center.

22. The method of claim 16, further comprising detecting variations, corresponding to components of the processor, in one or more of: temperature, operating frequency, operating voltage, and power consumption.

23. The method of claim 16, further comprising generating a signal indicative of a sampling rate, wherein determining the first value and the second value are performed at the sampling rate.

24. A computer-readable medium comprising one or more instructions that when executed on a processor configure the processor to perform one or more operations to:
determine a first value of power consumption over a first time interval of a plurality of time intervals, corresponding to a plurality of power consumption limits;
determine a second value of power consumption over a second time interval of the plurality of time intervals; and
compare the first value and the second value with two corresponding power consumption limit values from the plurality of power consumption limits to determine a power limit value,
wherein a level of power consumption by a processor is to be modified based on the determined power limit value.

25. The computer-readable medium of claim 24, further comprising one or more instructions that when executed on a processor configure the processor to perform one or more operations to set the plurality of power consumption limits and corresponding time intervals during system boot or run time.

26. The computer-readable medium of claim 24, further comprising one or more instructions that when executed on a processor configure the processor to perform one or more operations to set the plurality of power consumption limits and corresponding time intervals by an operating system, based on memory mapped input/output, or by a power manager unit of a system, computer rack, or a data center.

27. The computer-readable medium of claim 24, further comprising one or more instructions that when executed on a processor configure the processor to perform one or more operations to detect variations, corresponding to components of the processor, in one or more of: temperature, operating frequency, operating voltage, and power consumption.

28. The computer-readable medium of claim 24, further comprising one or more instructions that when executed on a processor configure the processor to perform one or more operations to generate a signal indicative of a sampling rate, wherein determining the first value and the second value are performed at the sampling rate.

29. A system comprising:
a processor having a plurality of processor cores;
memory to store a plurality of time intervals and corresponding power consumption limits;
first logic to determine a first value of power consumption over a first time interval of the plurality of time intervals and to determine a second value of power consumption over a second time interval of the plurality of time intervals;
second logic to compare the first value and the second value with two corresponding power consumption limit values from the plurality of power consumption limits to determine a power limit value, wherein a level of power consumption by the processor is to be modified based on the determined power limit value; and
a voltage regulator to supply power to at least one of the plurality of processor cores based on the determined power limit value.

30. The system of claim 29, further comprising third logic to cause modification to the level of power consumption by the processor based on the determined power limit value.

31. The system of claim 29, wherein a timer is to generate a signal indicative of a sampling rate, wherein the first logic is to determine the first value or the second value at the sampling rate.

32. The system of claim 29, further comprising an audio device.

33. The system of claim 29, wherein the first value of power consumption corresponds to a first average value of power consumption and the second value of power consumption corresponds to a second average value of power consumption.

34. The system of claim 29, wherein the power limit value is to correspond to a minimum power limit value.
